(19) United States
(12) Patent Application Publication
(10) Pub. No.: US 2014/0295129 A1
(43) Pub. Date: Oct. 2, 2014

(54) METHOD FOR PRODUCING A PLASTIC TRIM PART

(71) Applicant: SAINT-GOBAIN GLASS FRANCE, Courbevoie (FR)

(72) Inventors: Thomas Lux, Weissach Im Tal (DE); Ulrich Riegler, Lindhorst (DE); Ahmet Turan, Allmersbach Im Tal (DE); Rym Benyahia, Stuttgart (DE)

(73) Assignee: SAINT-GOBAIN GLASS FRANCE a corporation

(21) Appl. No.: 14/347,392

(22) PCT Filed: Sep. 5, 2012
(86) PCT No.: PCT/EP2012/067298

§ 371 Date: Jun. 9, 2014

(30) Foreign Application Priority Data
Oct. 5, 2011 (EP) 11183930.4

(51) Int. Cl. B29C 45/14; B32B 3/08

(52) U.S. Cl. CPC B29C 45/14; B32B 3/08
USPC 428/76; 264/259; 264/101; 264/478; 264/129

(57) ABSTRACT

A method for producing a plastic trim part is described. The method has the following steps: laying a polymer film in an injection die, where the polymer film has an opaque or partially opaque imprint or color pigmentation which is decomposition-stable at a temperature of at least 250° C., back injecting the polymer film by a polymer carrier component and injecting a polymer cover part on the polymer film and the polymer carrier component.

The invention comprises a method for producing a plastic trim part, a plastic trim part, and its use.

As part of increasingly stringent requirements regarding carbon dioxide emissions of motor vehicles, there are also strong efforts to reduce the weight of a motor vehicle and thus its fuel consumption. Constant innovations in the plastics sector enable the replacement of large parts of the metal car body by correspondingly lighter elements made of polymer materials. In particular, parts of or even the entire window region can be replaced by elements made of polymer materials. In many cases, along with a clearly lower weight, these present hardness, stability, and toughness comparable to that with a car body window made of steel. In addition, due to the weight reduction, the center of gravity of the motor vehicle is moved lower, which has a positive effect on handling. Moreover, compared to metals, polymer materials can be produced, processed, and shaped at significantly lower temperatures. This reduces the energy demand and costs during production of the materials.

Molded parts made of polymer materials can be produced in virtually any desired shape and geometry. Special high-performance plastics such as aramide or kevlar, for example, have very high strength and stability.

Many material parts made of plastics must fulfill various requirements and functions. In this regard, important parameters are stability, fracture behavior, scratch resistance, impact strength, or notched impact strength. In addition to technical considerations such as weight and strength of the individual components, shape, geometry, and appearance also play an increasingly important role. Especially in the automobile industry, besides mechanical properties, characteristics in the area of design and aesthetics are also of great significance.

In order to combine various characteristics in polymer materials, they are composed of basic materials of different shapes and different natures. Established methods for producing these materials include two-component or multicomponent injection molding methods. It is thus possible to combine characteristics such as weather resistance, surface gloss, and fracture resistance or torsional stability with each other. In addition, the shares of very expensive materials can be reduced.

DE 196 33 959 A1 discloses a molded article made up of a carrier and an outer decorative film. The outer film has a decorative layer and a protective layer, with the protective layer consisting of a photopolymerizable resin composition.

WO 2006/094484 A1 discloses a method for producing a flat, plastic autobody part containing two components. In a preferred embodiment, the first component is made of a transparent polycarbonate and the second component is made of an opaque polycarbonate.

DE 197 22 551 A1 discloses a method for producing plastic parts in the two-component injection molding process.

EP 1 695 808 A1 discloses a trim part for a motor vehicle, for example, a trim strip. The trim part comprises a carrier part made of a thermoplastic plastic and a cover part. The trim part is preferably produced by a multicomponent injection molding process.

One established method for producing optical effects and for surface sealing is the method for film insert molding (FIM). In this method, an appropriate film is laid in the injection mold and back injected with a suitable plastic. In this manner, the surface properties and geometry of polymer materials can be affected and modified selectively and versatilely. However, temperature stable films are an important prerequisite for the use of the method of film insert molding. Moreover, imprints situated on the film must also be temperature resistant enough to survive back injection with a liquid polymer such as polycarbonate. The method moreover does not permit the selective modification of a material within the polymer phase. In particular, transparent materials offer a wide range for spatial and visual design possibilities.

The object of the invention is to make available a method which can adjust and alter the optical properties and the appearance of a material element with partially transparent sections.

The object of the invention is accomplished by a method according to claim 1. Preferred embodiments emerge from the subclaims.

A plastic trim part according to the invention and the use of a plastic trim part emerge from other independent claims. Preferred embodiments emerge from the subclaims.

The method according to the invention for producing a plastic trim part comprises a first step in which a polymer film is laid in an injection mold. Following that, the polymer film is back injected with an opaque polymer material phase, which forms the carrier part of the plastic trim part. In the context of the invention, the term “film” encompasses both homogeneous, single component, or multicomponent films and woven, braided, or coated multicomponent films or textiles made of different or identical materials. The polymer film is preferably fixed on the steel surface of the injection mold by means of electrostatic interactions. The electrostatic charge is preferably transferred without contact to the polymer film via charging electrodes that are supplied with high voltage from charge generators. Alternatively, the polymer film can be fixed in the injection mold mechanically or by vacuum suction. The liquid starting material of the polymer carrier material is injected onto the film in the injection mold and a material bond between the polymer film and carrier part is thus obtained. The polymer carrier part ensures the stability of the plastic trim part and contains polymer materials with the greatest possible strength, scratch resistance, impact resistance or notch impact resistance and low fracture susceptibility. In an alternative embodiment, the carrier part is first injection molded and after the opening of the injection mold, a polymer film, preferably a self-adhesive polymer film, is arranged on the finished carrier part. The polymer film has an opaque or partially opaque imprint or color pigmentation stable against decomposition at a temperature of at least 250° C., preferably at least 320° C. In the context of the invention, the term “partially opaque imprint” also includes colored imprints and printing in grayscale. The opaque imprint preferably contains a printing ink with temperature stable organic pigments, for example, urethane-acrylate polymers, carbon, azo dyes, or polycyclic compounds. Alternatively, inorganic pigments can be contained, such as titanium dioxide, carbon black, cinnabar, bismuth (bismuth vanadate), spinel pigments, lead, mercury, zircon, iron, cadmium, copper, cobalt, nickel, chromium pigments; aluminosilicates (ultramarine). Due to the higher temperature stability, inorganic pigments are preferably used. In an alternative embodiment, the color pigments can also be homogeneously incorporated into the polymer film. This can, for example, be done by admixing the colored pigments into a granulate of the polymer film with subsequent extrusion of the resultant mixture. In another possible option, the colored pigments can be sprayed in a solution onto the polymer film. In a final step, a polymer cover part is injected onto the structure made up of the polymer film and the polymer carrier part. The polymer cover part is preferably implemented optically transparent. The polymer cover part preferably has a mean optical transparency of more than 60% (averaged over the wavelength), preferably more than 80% in the range from 400 nm to 800 nm. The high optical transparency gives the polymer cover part a glasslike appearance with low weight and high formability.

The plastic trim part is preferably produced in the multicomponent injection molding process or in the multicomponent injection-compression process, particularly preferably in combination with turning plate, rotary table, and/or index plate technology. Alternatively, the plastic trim part can also be produced using turning plate, rotary table, and/or index plate technology alone.

The polymer carrier part preferably contains polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene-polycarbonate (ABS/PC), PET/PC, PBT/PC, and/or copolymers or mixtures thereof.

The polymer carrier part is preferably implemented opaque or partially opaque. The opaque coloring of the polymer carrier part highlights the imprint of the polymer film through the contrast with the preferably transparent polymer cover part.

The polymer carrier part is preferably injection molded in a thickness from 0.5 mm to 10 mm, particularly preferably 1 mm to 5 mm. The thickness of the polymer carrier part depends on the dimensions and stability requirements of the finished component.

A hardcoat, particularly preferably thermal-cured or UV-cured varnishes, more particularly preferably polysiloxanes, polyacrylates, polymethacrylates, and/or mixtures or copolymers thereof is applied on the polymer cover part. The hardcoat improves the resistance to ageing, mechanical effects of wear, scratch damage, weathering effects, UV radiation, and/or aggressive chemicals from the air or water spray. In addition, the hardcoat can also perform decorative functions as well, such as gloss or pearl effects.

The polymer film preferably contains polycarbonates (PC), polymethyl methacrylate (PMMA), polyethylene terephthalate (PET), polybutylene terephthalate (PBT), polycarbonate-polybutylene terephthalate (PBT/PC), styrene acrylonitrile (SAN), and/or copolymers or mixtures thereof.

The polymer film preferably has a thickness from 0.1 mm to 3 mm, preferably 0.12 mm to 1 mm. The size can vary depending on the dimensioning of the polymer carrier part and of the polymer cover part. The polymer film is preferably preformed, particularly preferably thermally preformed. The prior forming of the polymer film permits better adaptation to the geometry of the cover part. This also prevents infiltration of the polymer material phase between the polymer carrier part and the polymer film at the time of back injection of the polymer film with the polymer carrier part.

The invention further includes a plastic trim part that comprises at least a polymer carrier part, a polymer cover part, and a polymer film. The polymer film is arranged between the polymer carrier part and the polymer cover part, with the polymer film having an opaque or partially opaque imprint stable against decomposition at at least 250° C., preferably 320° C. The polymer carrier part ensures the stability of the plastic trim part and includes, as described above, polymer materials such as polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene-polycarbonate (ABS/PC), PET/PC, PBT/PC, and/or copolymers or mixtures thereof.

The polymer carrier part preferably contains inorganic or organic fillers, particularly preferably SiO₂, Al₂O₃, TiO₂, clay minerals, silicates, zeolites, glass fibers, carbon fibers, glass beads, organic fibers, and/or mixtures thereof. The fillers can further increase the stability of the carrier part. Moreover, the fillers can reduce the share of polymer materials and thus reduce the production costs of the component.

The polymer cover part can assume both decorative functions and functions in the area of tool resistance. Examples of this are surfaces or coatings that increase weather, UV, or chemical resistance. The polymer film serves as the carrier of the opaque or partially opaque imprint stable against decomposition at at least 250° C., preferably 320° C. The high temperature stability of the opaque or partially opaque imprint is necessary, since, otherwise, the imprint or the color pigments would decompose or leach out when the polymer cover part is injected on. The opaque or partially opaque imprint is preferably thermally stable against decomposition in the range from 150° C. to 350° C., particularly preferably 200° C. to 320° C. The polymer film is likewise preferably thermally stable against decomposition at at least 150° C., particularly preferably at least 320° C.; otherwise gas bubbles and discolorations could form in the finished workpiece in the region of the polymer film.

The polymer carrier part is preferably implemented opaque and the polymer cover part is preferably implemented transparent. In this embodiment, the opaque or partially opaque imprint is quite readily visible.

The polymer film is preferably thermally stable against decomposition in the range from 200° C. to 300° C. Here, suitable film materials are especially polymethyl methacrylate (PMMA) and polycarbonate (PC). These polymer films can be injected with a variety of transparent polymers that form the cover part. In an alternative embodiment, the polymer film can also be colored or tinted black or gray.

An edge region from 0.1 cm to 5 cm without the polymer film is preferably arranged between the polymer carrier part and the polymer cover part. The edge region without film ensures a very uniform edge seal. In addition, the edge region can assume decorative functions.

The invention further includes the use of the plastic trim part for interior and exterior applications in motor vehicles, preferably pillar cover, dashboard elements, or switch panels. The plastic trim part is preferably used as an A, B, or C pillar covering in motor vehicles.

In the following, the invention is explained in detail with reference to drawings. The drawings are a purely schematic representations and are not true to scale. They in no way restrict the invention.

They depict:

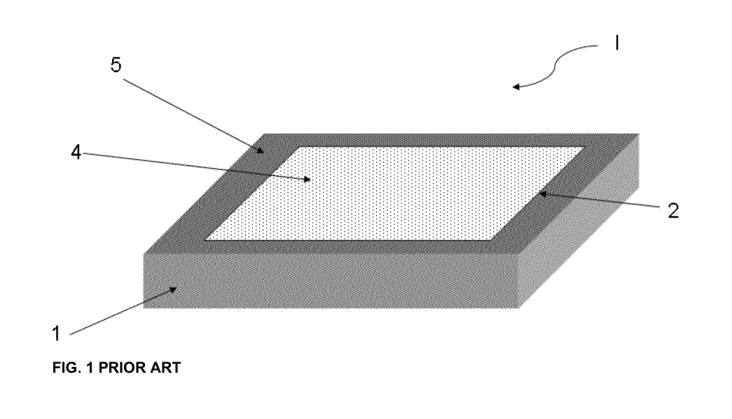

FIG. 1 a schematic view of a plastic trim part according to the prior art,

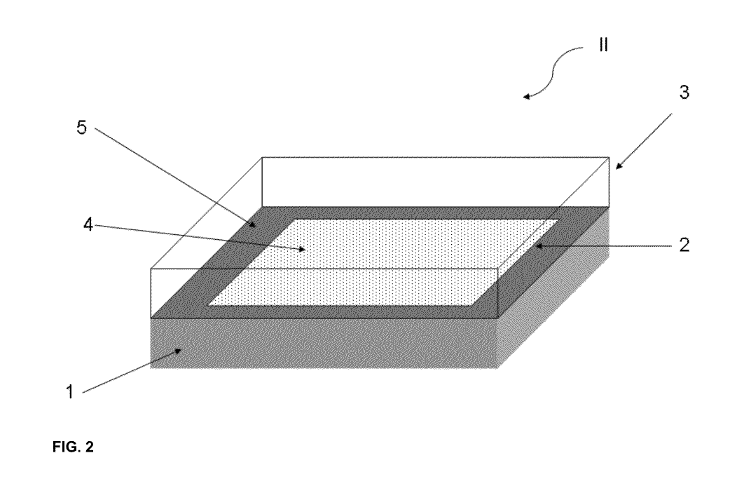

FIG. 2 a schematic view of a plastic trim part according to the invention, and

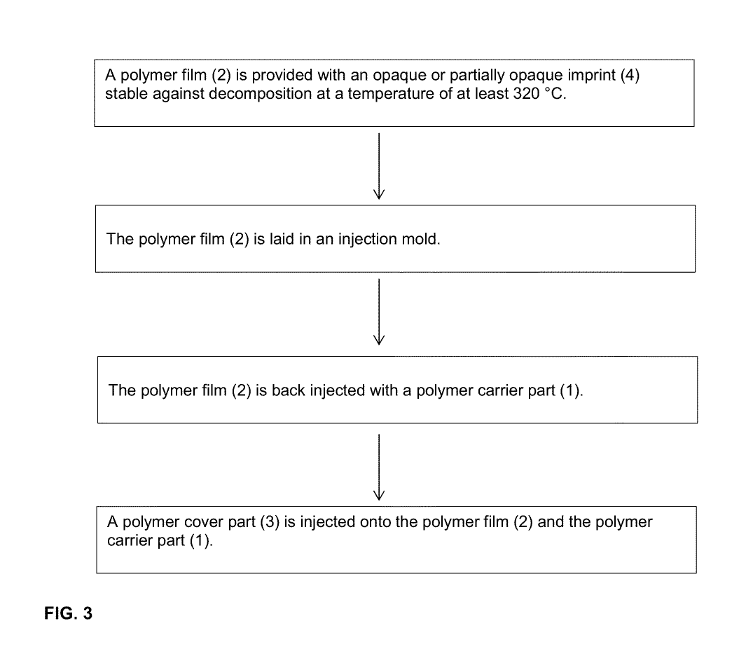

FIG. 3 a flowchart of the method according to the invention for producing a plastic trim part.

FIG. 1 depicts a schematic view of a plastic trim part (I) according to the prior art. A polymer film (2) with a decorative imprint (4) is arranged on a polymer carrier part (1), for example, a part of the dashboard of a motor vehicle. The edge region (5) can be designed both in the same color as the polymer carrier part (1) and in a different color.

FIG. 2 depicts a schematic view of a plastic trim part (II) according to the invention. A transparent polymer cover part (3) made of PC or PMMA is arranged on an opaque polymer carrier part (1) made of acrylonitrile butadiene styrene (ABS). A polymer film (2) with a decorative imprint (4) is arranged between the polymer carrier part (1) and the polymer cover part (3). The transparent polymer cover part (3) protects the polymer film (2) against UV radiation and abrasion as well as damage and, at the same time, creates a glasslike effect on the surface of the decorative imprint (4) (for example, spinel black No. 38, copper-chromium-iron-spinel, Kremer Pigmente GmbH & Co. KG, Aichstetten, Germany) on the polymer film. The polymer film (2) with a decorative imprint (4) is surrounded by the edge region (5).

FIG. 3 depicts a flowchart of the method according to the invention for producing a plastic trim part (II) according to the invention. In a first process step, a polymer film (2) is provided with an opaque or partially opaque imprint (4) stable against decomposition at a temperature of at least 320° C. The imprint (4) is preferably applied by a screen printing or inkjet printing method. The polymer film (2) is then laid in an injection mold and back injected with a polymer carrier part (1) (the liquefied polymer material of the polymer carrier part). In a final step, a polymer cover part (3) is injected onto the polymer film (2) and the polymer carrier part (1). After the curing of the polymer cover part (3), a hardcoat is also preferably applied to improve mechanical and chemical resistance. In particular, in the case of a cover part made of polycarbonate (PC), a hardcoat is preferably applied. The hardcoat can be applied on the polymer cover part by flooding, spraying, or dipping methods. With coating of the polymer cover part (2) with polysiloxane hardcoat, even the very high requirements that are usually only applied to safety glazing can be met (Rigid Plastic Glazings, ECE R43 Annex 14, Class/M).

### LIST OF REFERENCE CHARACTERS

(1) polymer carrier part

(2) polymer film

(3) polymer cover part

(4) imprint

(5) edge region

(I) plastic trim part according to the prior art

(II) plastic trim part according to the invention

1. A method for producing a plastic trim part, comprising: wherein
laying a polymer film in an injection mold, wherein the polymer film has an opaque or partially opaque imprint or color pigmentation stable against decomposition at a temperature of at least 250° C.,
back injecting the polymer film with a polymer carrier part, and
injecting a polymer cover part onto the polymer film and the polymer carrier part.

2. The method according to claim 1, wherein the polymer carrier part contains polyethylene (PE), polycarbonates (PC), polypropylene (PP), polystyrene, polybutadiene, polynitriles, polyesters, polyurethanes, polymethyl methacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene-polycarbonate (ABS/PC), PET/PC, PBT/PC, and/or copolymers or mixtures thereof.

3. The method according to claim 1, wherein the polymer carrier part is opaque.

4. The method according to claim 1, wherein the polymer carrier part is injection molded in a thickness from 0.5 mm to 10 mm, preferably 1 mm to 5 mm.

5. The method according to claim 1, wherein the polymer cover part contains polycarbonates (PC), polymethyl methacrylate (PMMA), styrene acrylonitrile (SAN), polyethylene terephthalate (PET), and/or copolymers or mixtures thereof.

6. The method according to claim 1, wherein the polymer cover part is transparent.

7. The method according to claim 1, wherein a hardcoat is applied on the polymer cover part.

8. The method according to claim 1, wherein the polymer film contains polycarbonates (PC), polymethyl methacrylate (PMMA), polyethylene terephthalate (PET), polybutylene terephthalate (PBT), polycarbonate-polybutylene terephthalate (PBT/PC), styrene acrylonitrile (SAN), and/or copolymers or mixtures thereof.

9. The method according to claim 1, wherein the polymer film has a thickness from 0.1 mm to 3 mm, preferably 0.12 mm to 1 mm.

10. The method according to claim 1, wherein the polymer film is preformed, preferably thermally preformed.

11. The method according to claim 1, wherein the polymer film is fixed in the injection mold by electrostatic discharge, mechanically, or by vacuum suction.

12. A plastic trim part comprising:
a polymer carrier part,
a polymer cover part, and
a polymer film between the polymer carrier part and the polymer cover part,
wherein:
the polymer film has an opaque or partially opaque imprint or color pigmentation stable against decomposition at least 250° C.,
the polymer carrier part is opaque and the polymer cover part is transparent, and
an edge region of 0.1 cm to 5 cm without the polymer film is arranged between the polymer carrier part and the polymer cover part.

13. The plastic trim part according to claim 12, wherein the polymer film is thermally stable against decomposition in the range from 200° C. to 320° C.

14. The plastic trim part according to claim 12, wherein the imprint contains organic pigments or inorganic pigments, preferably urethane-acrylate polymers, carbon, azo dyes, or polycyclic compounds, titanium dioxide, carbon black, cinnabar, bismuth-(bismuth vanadate), spinel pigments, lead, mercury, zircon, iron, cadmium, copper, cobalt, nickel, chromium pigments, aluminosilicates, ultramarine.

15. A method comprising:
using the plastic trim part according to claim 12 in motor vehicles, preferably pillar coverings, dashboard elements, or switch panels.

16. The method according to claim 4, wherein the thickness is from 1 mm to 5 mm.

17. The method according to claim 7, wherein the hardcoat is thermal-cured or UV-cured varnishes.

18. The method according to claim 17, wherein the varnishes are polysiloxanes, polyacrylates, polymethacrylates, and/or mixtures or copolymers thereof.
